(19) United States
(12) Patent Application Publication
(10) Pub. No.: US 2006/0023840 A1
(43) Pub. Date: Feb. 2, 2006

(54) Method for imaging in a medical interventional procedure by image subtraction

(76) Inventor: Jan Boese, Eckental (DE)

Correspondence Address: SCHIFF HARDIN, LLP;PATENT DEPARTMENT, 6600 SEARS TOWER, CHICAGO, IL, 60606-6473, US

(21) Appl. No.: 11/187,191

(22) Filed: Jul. 22, 2005

(30) Foreign Application Priority Data
Jul. 23, 2004 (DE) 10 2004 035 980.6

(51) Int. Cl. H05G 1/64

(52) U.S. Cl. 378/98.12

(57) ABSTRACT

In a method for imaging in a medical interventional procedure, in which an image of structures (in particular vessels) of a body region is generated during the procedure, image data of a first 2D x-ray image of the body region that is generated with a contrast agent enhancement of the structures, and image data of at least one second 2D x-ray image of the body region that is acquired without contrast agent enhancement of the structures, are subtracted from one another. The image data of the first 2D x-ray image are calculated from a 3D volume data set of a computed tomography exposure of the body region. Movement artifacts due to movements of the patient between the generation of a mask image and subsequent fluoroscopy images thus are prevented or at least reduced without time-consuming user interaction.

### BACKGROUND OF THE INVENTION

1. Field of the Invention

The present invention concerns a method for imaging in a medical interventional procedure, in particular of the type using a pathfinder technique in which an image of structures (in particular vessels) of a body region is generated during the procedure, wherein image data of a first 2D x-ray image of the body region are generated with a contrast agent enhancement of the structures, and image data of at least one second 2D x-ray image of the body region are acquired without contrast agent enhancement of the structures, the images being subtracted from one another.

2. Description of the Prior Art

The technique known as the pathfinder technique, also known by the term road mapping, is used in the selective catheterization of vessels in the framework of an interventional treatment. In these vessel interventions, the current position of an x-ray-absorbing catheter or guide wire is shown in a two-dimensional image using x-ray radiography (fluoroscopy). In order to be able to additionally detect the blood vessel for use as a “road map,” at the beginning of the intervention an image is acquired in which a slight quantity of contrast agent has been injected. This image is retained as a mask image. The mask image is logarithmically subtracted from the subsequent fluoroscopy images acquired without injection of a contrast agent. In this manner subtraction images are obtained in which the catheter can be detected as darker compared to the light blood vessels, and the background has been eliminated by the subtraction.

The road mapping is, however, by movements of the imaged structures between the acquisition of the mask image and the acquisition of the fluoroscopy image. First, the background is no longer correctly subtracted such that image artifacts are created. Additionally, it may occur that the position of the instrument obtained in the image is not correct relative to the shown blood vessel. This error can lead, for example, to the catheter showing outside of the vessel in the image although it is actually located within the vessel. In the extreme case, such false representations can lead to errors in the catheter control and vessel injuries as a result. If a movement of the patient occurs during the intervention, the roadmap must therefore frequently be refreshed by a re-acquisition of the mask image. This requires additional expenditure of time and contrast agent consumption and represents an increased radiation dose for the patient.

Different solutions are known to prevent or reduce this problem. The primary method currently in use is based on a 2D image processing of mask images and fluoroscopy images. Automatic methods that establish the best congruence using quantifiable similarity measurements are available in some commercial angiography systems. This image processing, however, can only approximately compensate for the movements. Arbitrary movements cannot be unambiguously determined from the two-dimensional images.

A method for positioning a catheter is known from U.S. Pat. No. 6,370,417, in which a few two-dimensional mask images are acquired from various acquisition angles and stored. If a mask image from an arbitrary direction is required, the best-fitting image from the stored mask images is selected.

### SUMMARY OF THE INVENTION

An object of the present invention is to provide a method for imaging in an interventional medical procedure, with which movement artifacts due to movements of the patient between the generation of a mask image and subsequent fluoroscopy images can be prevented or at least reduced without time-consuming user interaction.

This object is achieved in accordance with the invention by a method, wherein 3D volume data of a body region of a patient from an x-ray computed tomography exposure (in particular a 3D rotation angiography exposure obtained with a C-arm apparatus) are used that are either acquired immediately before the interventional procedure after contrast agent injection, or that may already be present from preceding examinations. X-ray computed tomography is a special x-ray slice acquisition method in which transversal slice images, i.e. images of body slices oriented essentially perpendicular to the body axis, are acquired. For this purpose, the examination volume is exposed in slices from a number of angles so that a three-dimensional volume data set is acquired. 2D x-ray exposures are calculated from this 3D volume data using suitable projection methods.

In the inventive method, at least one conventional 2D x-ray exposure (fluoroscopy image) of the body region of interest of the patient is now made during the interventional procedure in order to obtain image data of the body region at this point in time. The image data of the same body region, however, are not acquired from further 2D x-ray exposures after a contrast agent enhancement of the structures to be shown, but rather in the inventive method are calculated from the already-present 3D volume data. For each volume element (voxel) of the acquired body region, these 3D volume data exhibit a density value that represents the transmissibility (permeability) of this voxel for x-ray radiation with the addition of contrast agent. The calculation of the 2D image data from the 3D volume data ensues in a known manner using the x-ray absorption model with which the density distribution is calculated, which is obtained as an x-ray image from the given projection direction upon irradiation of this body region. A method for generation of such artificial x-ray images, also called DRR (digitally-reconstructed radiographs) is described in Robert L. Siddon: Fast Calculation of the Exact Radiological Path for a Three-Dimensional CT Array, Medical Physics 12(2), 252-255, March 1985. In this manner, a mask image is obtained that can be subtracted in a known manner from the fluoroscopy image in order to obtain the image of the structures to be shown with the interventional instrument, for example a catheter. The subtraction ensues on the basis of the digital image data of both images that are acquired from logarithmic measurement values of the x-ray detector.

The correct projection direction given the calculation of the mask image is ensured by a registration (i.e. the establishment of a spatial correlation of the coordinate systems) of the 2D x-ray exposure for the fluoroscopy image to the 3D volume data set, such that the image data of the fluoroscopy and mask image are acquired from the same projection direction. Suitable methods for registration of medical image data are known to the average man skilled in the art, for example from Med Phys. 2001 June, 28(6), pages 1024 through 1032, “Validation of a two- to three-dimensional registration algorithm for aligning preoperative CT images and intraoperative fluoroscopy images” by G. P. Penney et al.

The 2D/3D registration as well as the calculation of a suitable mask image from the 3D volume data set is repeated for each further fluoroscopy image that is acquired during the interventional procedure.

With the inventive method, it is thus possible to compensate for image artifacts due to arbitrary patient movements in which an optimal artificial 2D mask image fitting the fluoroscopy image is automatically calculated from the 3D volume data set. In the long term, time, contrast agent and x-ray dose are saved via the improved compensation of the patient movement, since a repeated acquisition of mask images is no longer necessary.

Since the projection directions can be freely predetermined in the calculation of a mask image, the further 2D x-ray exposures for generation of the fluoroscopy images also do not have to ensue from the respective same projection direction. By the registration of each 2D x-ray exposure, it is ensured that the correct mask image for each fluoroscopy image can respectively be calculated from an arbitrary projection direction from the 3D volume data.

### DESCRIPTION OF THE DRAWINGS

FIG. 1 is a flowchart given of an exemplary embodiment of the inventive method.

FIG. 2 schematically illustrates the acquisition of a 3D volume data set with contrast agent enhancement.

FIG. 3 schematically illustrates the image processing for the implementation of the movement correction in accordance with the invention.

### DESCRIPTION OF THE PREFERRED EMBODIMENTS

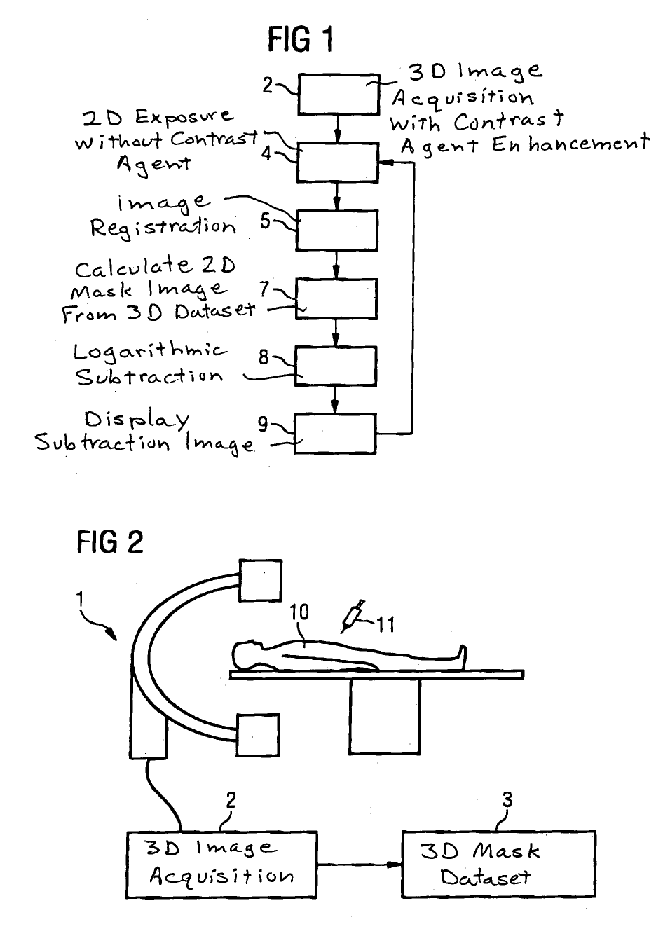

FIG. 1 shows an exemplary flowchart for implementation of the inventive method for imaging in an interventional procedure on a patient. A 3D volume data set of the patient, or at least of a body region of the patient, is initially generated with contrast agent injection. The acquisition of this data set can ensue either with an x-ray computed tomography system or with an angiography system with a C-arm.

The acquisition of the 3D volume data of a body region of interest of a patient 10 with a C-arm angiography system 1 is illustrated in FIG. 2. the 3D image acquisition 2 is implemented after a contrast agent injection 11. The image data acquired by image reconstruction from the measurement values of the 3D image acquisition 2 are stored as a 3D mask data set 3 and thus are available for later further processing. This first step of this acquisition of a 3D volume or mask data set can ensue with an x-ray dose that is reduced relative to that for diagnostic 3D rotation angiography and/or with a reduced number of projections and/or with a reduced acquisition matrix.

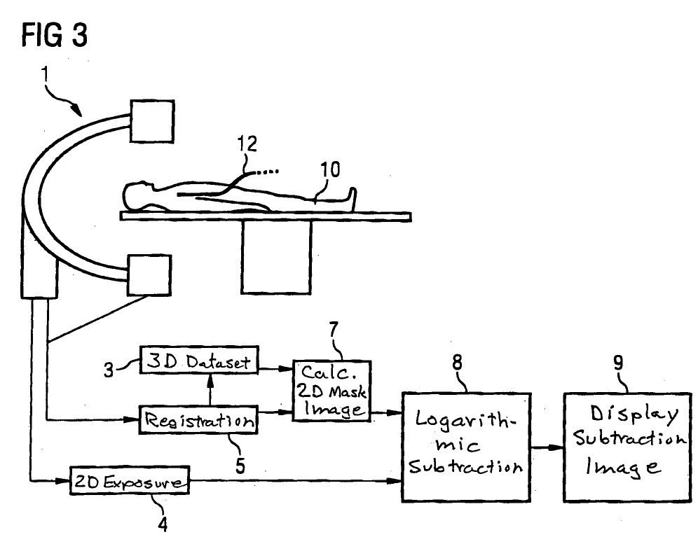

In the implementation of the interventional procedure (for example with a catheter 12) according to the inventive method, in the desired viewing or projection direction the physician makes a 2D x-ray exposure 4 of the body region of interest without contrast agent administration, in order to obtain a fluoroscopy image as is schematically shown in FIG. 3. In the present example, this 2D x-ray acquisition 4 ensues with the same C-arm angiography system 1 with which the 3D image exposure 2 was acquired. This makes the subsequent 2D/3D registration step 5 easier.

The 3D mask data 3 and the 2D x-ray exposure 4 are registered in the registration step 5 with a method for digital image processing, such that an exact association of the projection direction of the 2D x-ray exposure 4 with the 3D mask data 3 is possible. For this purpose, the known current geometry parameters of the angiography system 1 are used as a starting point. The various positions and orientations of the detector and the x-ray focus as well as of the patient bed are among to these parameters. The angulation of the C-arm in the 2D x-ray exposure 4 can be used for initial estimation of the projection direction for the calculation of the 2D mask image from the 3D mask data 3. A voxel-based method is used for the optimization that optimizes parts of the six extrinsic and five intrinsic degrees of freedom of the 2D/3D registration (six degrees for rotation and translation of the 3D data set and five degrees for the projection geometry) by comparison between the fluoroscopy image acquired from the 2D x-ray exposure 4 and calculated (and thus artificially-generated) projections from the 3D mask data set 3. Patient movements and inaccuracies in the geometry of the x-ray system of the angiography system 1 can be compensated in this manner.

If the C-arm moves in a reproducible manner, the projection geometry can be determined by calibration so that individual or all intrinsic parameters can be omitted from the optimization. In principle, an elastic 2D/3D registration with more than six extrinsic degrees of freedom is also possible. In this case, deformations of the examination region can also be compensated in addition to the rotation and translation.

After the registration 5, a projection coinciding with the 2D x-ray exposure 4 is calculated as a 2D mask image from the 3D mask data set 3 (step 7).

A movement-compensated subtraction image in which the interventional tool (for example the catheter 12) is visible in the vessel is obtained from the calculated 2D mask image and the fluoroscopy image by logarithmic subtraction 8 of the image data. The subtraction image is stored and shown on the monitor of the angiography system 1 (step 9).

The steps shown in FIG. 3 are continuously repeated during the procedure for every acquired fluoroscopy image in order to enable the physician to track the instrument in the examined body region.

Although modifications and changes may be suggested by those skilled in the art, it is the intention of the inventor to embody within the patent warranted hereon all changes and modifications as reasonably and properly come within the scope of the inventor's contribution to the art.

I claim as my invention:

1. A method for generating an image in a medical interventional procedure, comprising the steps of:
providing a 3D volume data set of a body region of a subject obtained by a computed tomography exposure of the body region with contrast agent enrichment of a structure in the body region;
obtaining a 2D x-ray image of the body region without contrast agent enhancement of said structure substantially contemporaneously with a medical interventional procedure with respect to the subject;
electronically calculating a 2D x-ray image of the body region with contrast agent enhancement of said structure, corresponding to said 2D x-ray image of the body region without contrast agent enhancement, from said 3D volume data set; and
subtracting said 2D x-ray image of the body region without contrast agent enhancement from said 2D x-ray image of the body region with contrast agent enhancement to obtain a resulting image showing substantially only said structure.

2. A method as claimed in claim 1 comprising obtaining said 2D x-ray image without contrast agent enhancement during said medical interventional procedure.

3. A method as claimed in claim 1 comprising obtaining said 3D volume data set of said body region by 3D rotation angiography.

4. A method as claimed in claim 1 comprising obtaining said 3D volume data set of said body region substantially in advance of said medical interventional procedure, and electronically storing said 3D volume data set in a memory.

5. A method as claimed in claim 1 comprising obtaining said 3D volume data set using a C-arm CT apparatus, and acquiring said 2D x-ray image of the body region without contrast agent enhancement using said C-arm CT apparatus.

6. A method as claimed in claim 1 wherein the step of electronically calculating said 2D x-ray image of the body region with contrast agent enhancement includes digitally registering said 2D x-ray image of the body region without contrast agent enhancement with said 3D volume data set.
